(19) United States
(12) Patent Application Publication
(10) Pub. No.: US 2026/0264569 A1
(43) Pub. Date: Sep. 10, 2026

(54) BATTERY CONTROL APPARATUS, BATTERY CONTROL METHOD, AND VEHICLE CONTROL APPARATUS

(71) Applicant: VEHICLE ENERGY JAPAN INC., Ibaraki (JP)

(72) Inventors: Shuko YAMAUCHI, Tokyo (JP); Ryohei NAKAO, Tokyo (JP); Kei SAKABE, Ibaraki (JP)

(21) Appl. No.: 19/163,478

(22) PCT Filed: Feb. 26, 2024
(86) PCT No.: PCT/JP2024/006880

§ 371 Date: Sep. 9, 2025

(51) Int. Cl. B60L 58/16; B60L 58/12; H01M 10/42

(52) U.S. Cl. CPC B60L 58/16; B60L 58/12; H01M 10/425; H01M 2010/4271; H01M 2220/20

(57) ABSTRACT

The application provides a battery control apparatus (200) that includes: a deterioration calculation unit 232 configured to calculate a deterioration degree of a battery 101; a deterioration prediction unit 502 configured to predict the deterioration degree of the battery; and an assembled-battery control management unit 230 configured to limit charge/discharge of the battery based on comparison between change over time of the deterioration degree of the battery obtained by calculation of the calculation unit and change over time of the deterioration degree of the battery obtained by prediction of the prediction unit.

### TECHNICAL FIELD

The present invention relates to a battery control apparatus, a battery control method, and a vehicle control apparatus.

### BACKGROUND ART

To prevent global warming, reduction of carbon dioxide emissions is required. Therefore, for example, replacement of existing automobiles that use only gasoline engines as a power source, with hybrid electric vehicles that use a gasoline engine and an electric motor, electric vehicles that use only an electric motor, and the like is progressing. To reduce deterioration in vehicle performance caused by replacement, a large-size secondary battery as a power source for the hybrid electric vehicle and the electric vehicle is required to realize high output and a large capacity. A storage battery module configuring the large-size secondary battery is configured by coupling a plurality of secondary batteries (batteries) in series and parallel in order to realize high output and a large capacity. As the batteries, secondary batteries such as lithium ion batteries are generally used.

It is known that, when the secondary battery such as the lithium ion battery is continuously used at a large current, an internal resistance is specifically increased, and deterioration is accelerated. The specific resistance increase is gradually reduced by promptly stopping energization after detection of the resistance increase, and the secondary battery can be recovered after a long time of about several days. However, if detection of the resistance increase is delayed and a high load is continuously applied to the secondary battery, deterioration of the second battery is accelerated and fixed. Even when the secondary battery is rested for a long time to reduce the resistance once, the resistance is rapidly increased after the energization is resumed.

To suppress such increase of the internal resistance, a method of controlling a secondary battery has been proposed (for example, Patent Literature 1). In the method disclosed in Patent Literature 1, a plurality of periods and thresholds corresponding thereto are provided for a charge/discharge current of a rechargeable battery, and the charge/discharge current of the rechargeable battery is limited such that a total sum of the current during each of the periods or a total sum of square of the current becomes equal to or smaller than the corresponding threshold.

### CITATION LIST

### Patent Literature

[Patent Literature 1] Japanese Patent Laid-Open No. 2011-79447

### SUMMARY OF INVENTION

### Technical Problem

In the method disclosed in Patent Literature 1, a limit value of the current is reduced after resistance increase caused by continuation of a high load progresses. Therefore, deterioration of the secondary battery is accelerated, and even when energization to a load is stopped, a resistance value may not be recovered to a value before the specific increase. Further, when the limit value is set back to increase the current after the resistance value is recovered to some extent, the resistance may be rapidly increased in a short period as described above, and may exceed the threshold again. When such a state is established, limitation is frequently applied, and final deterioration of the battery becomes large. Therefore, to effectively utilize the battery up to a predicted lifetime, a performance margin in anticipation of the issue is necessary.

In terms of performance optimization, the margin is preferably small, and to minimize the margin, it is necessary to prevent occurrence of the above-described phenomena. The reason why these phenomena occur in the existing method is because it is difficult for the existing method to detect and prevent, at an early stage, the specific increase of the battery resistance caused by continuous operation of the battery under the high load. In other words, to effectively utilize the battery up to the predicted lifetime while minimizing the margin, it is necessary to detect and prevent, at an early stage, the specific increase of the battery resistance caused by continuous operation of the battery under the high load.

An object of the present invention is to provide a battery control apparatus, a battery control method, and a vehicle control apparatus that can secure stable output of a load while suppressing unexpected abnormal resistance increase caused by continuous operation of a battery under a high load and other factors, and can effectively use the battery up to a predicted lifetime.

### Solution to Problem

To achieve the above-described object, a battery control apparatus according to the present invention includes: a calculation unit configured to calculate a deterioration degree of a battery; a prediction unit configured to predict the deterioration degree of the battery; a determination unit configured to determine a state of the battery based on comparison between change over time of the calculated deterioration degree of the battery and change over time of the predicted deterioration degree of the battery; and a limiting unit configured to limit charge/discharge of the battery based on the determined state of the battery. The present invention further provides a battery control method and a vehicle control apparatus disclosed in the claims.

### Advantageous Effects of Invention

According to the present invention, it is possible to secure the stable output of the load while suppressing unexpected specific increase of the resistance value, and to effectively use the battery up to the predicted lifetime.

### BRIEF DESCRIPTION OF DRAWINGS

FIG. 1 is a block diagram illustrating a partial configuration of a vehicle including a battery control apparatus according to an embodiment of the present invention.

FIG. 2 is a block diagram illustrating a configuration of an assembled-battery control management unit of the battery control apparatus according to the embodiment.

FIG. 3 is a block diagram illustrating a configuration of a power limit calculation unit according to the embodiment.

FIG. 3A is an error map of a model prediction value SOHRest.

FIG. 3B is an error graph of the model prediction value SOHRest.

FIG. 4A is an error map of a detection value SOHRcalc.

FIG. 4B is an error graph of the detection value SOHRcalc.

FIG. 5 is a graph illustrating a relationship between the number of cycles and an SOHR in a secondary battery.

FIG. 6A is a graph illustrating a current value of a battery.

FIG. 6B is a graph illustrating variation of each of a model prediction value SOHRest and a detection value SOHRcalc of the battery.

FIG. 6C is a graph illustrating variation per time of each of the detection value SOHRcalc and the model prediction value SOHRest of the battery.

FIG. 7A is a graph illustrating change over time of a OCV and a CCV of the battery.

FIG. 7B is a graph illustrating change over time of a difference between the OCV and the CCV.

FIG. 8A is a graph illustrating a relationship between variation per time of the detection value SOHRcalc and variation per time of the model prediction value SOHRest in a method of controlling the battery reflecting increase of a resistance value of the battery.

FIG. 8B is a graph illustrating a relationship between the detection value SOHRcalc and the model prediction value SOHRest.

FIG. 8C is a graph illustrating SOHR calculation timings.

FIG. 9A is a graph illustrating change over time of a current detected by a current detection unit, about recovery of increase of the resistance value of the battery.

FIG. 9B is a graph illustrating change over time of the detection value SOHRcalc.

FIG. 10 is a graph for explaining change over time of a difference (dSOHRcalc/dt−dSOHRest/dt) in a second example of a method of determining increase of the resistance value of the battery.

FIG. 11 is an exemplary flowchart of a control method performed by the battery control apparatus.

FIG. 12A is a graph illustrating change over time of each of the detection value SOHRcalc and the model prediction value SOHRest for explaining effects by the battery control method performed by the battery control apparatus.

FIG. 12B is a graph illustrating change over time of a power limit value.

FIG. 12C is a graph illustrating change over time of a difference 1 (dSOHRcalc/dt−dSOHRest/dt).

### DESCRIPTION OF EMBODIMENT

An embodiment of the present invention is described with reference to drawings. In the description, to make clear dimensions such as a voltage V, a current I, a power W, a resistance value R, a temperature T, and a time t, symbols for respective dimensions are denoted even though the dimensions are not illustrated. Further, when specification of the dimensions is necessary, the symbols for the respective dimensions are added with suffixes. For example, a battery voltage Vu, an effective current Ie, a temperature T, an environmental temperature Ts, a maximum temperature Tmax, an average temperature Ta, a temperature Tu of each secondary battery (battery), and a minimum temperature Tmin are listed. Note that units of respective dimensions are substantially omitted throughout the specification and the drawings.

### (Configuration of Vehicle 1)

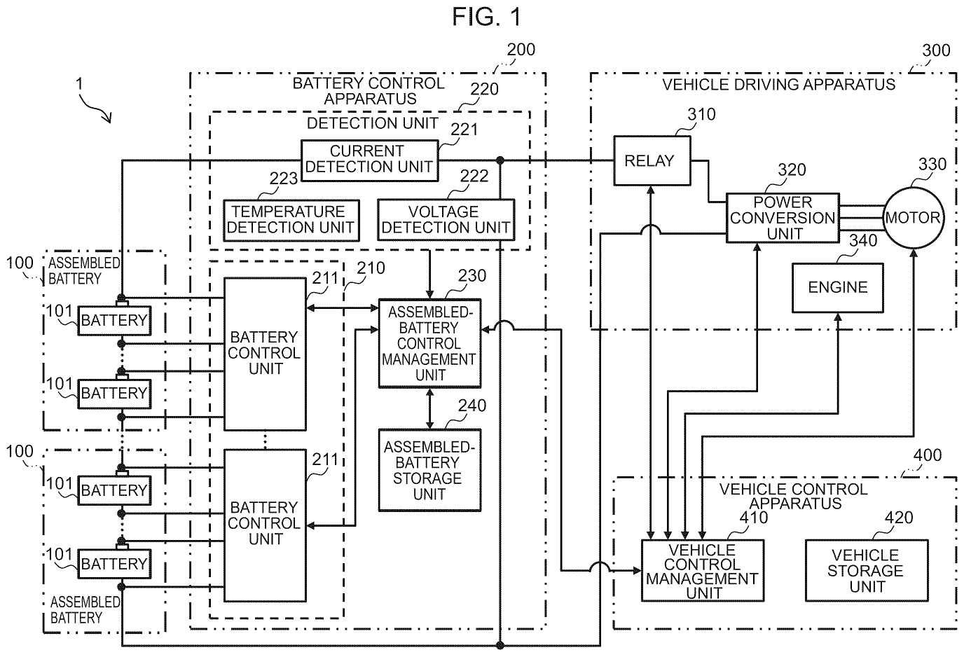

FIG. 1 is a block diagram illustrating a partial configuration of a vehicle 1 including a battery control apparatus according to the embodiment of the present invention. The vehicle 1 includes assembled batteries 100 supplying power to the vehicle 1, a battery control apparatus 200 controlling battery operation such as charge and/or discharge of the assembled batteries 100, a vehicle driving apparatus 300 driving the vehicle 1, and a vehicle control apparatus 400 controlling the battery control apparatus 200 and the vehicle driving apparatus 300.

The vehicle 1 is configured as a hybrid electric vehicle (HEV), an electric vehicle (EV), or a plug-in hybrid electric vehicle (PHEV).

### (Configuration of Vehicle Driving Apparatus 300)

The vehicle driving apparatus 300 drives the vehicle 1. The vehicle driving apparatus 300 includes a relay 310 supplying or interrupting power, a power conversion unit 320 that transforms the power while performing power conversion between DC power and AC power, a motor 330 used as a power source for the vehicle 1, and an engine 340 used as a power source for the vehicle 1.

The relay 310 is electrically coupled between the assembled batteries 100 and the power conversion unit 320. Therefore, the relay 310 supplies or interrupts power between the assembled batteries 100 and the motor 330 through the power conversion unit 320. In the present embodiment, the relay 310 is incorporated in the vehicle driving apparatus 300, but may be incorporated in the battery control apparatus 200. By incorporating the relay 310 in the battery control apparatus 200, the relay 310 can cut output voltages from the assembled batteries 100 when the assembled batteries 100 and the battery control apparatus 200 are assembled to or disassembled from the vehicle 1. This makes it possible to prevent an accident such as electric shock and short circuit.

The power conversion unit 320 is electrically coupled between the relay 310 and the motor 330. The power conversion unit 320 includes an inverter circuit and a converter circuit, and accordingly realizes AC-DC conversion and transformation necessary for power delivery between the assembled batteries 100 and the motor 330.

The motor 330 is a motor for vehicle traveling or for power generation, and is used as the power source for the vehicle 1 together with the engine 340. During vehicle traveling, the motor for vehicle traveling rotates tires of the vehicle 1 by using power of the assembled batteries 100. On the other hand, during power generation, the motor for power generation charges the assembled batteries 100 by using regenerative energy at deceleration. The motor for vehicle traveling and the motor for power generation may be integrated in order to reduce a cost and a space. The motor for vehicle traveling and the motor for power generation may be separately provided in order to optimize performance.

The engine 340 is used as the power source for the vehicle 1 together with the motor 330. The tires of the vehicle 1 are rotated and the motor 330 is rotated by the power of the engine 340.

By providing the above-described configuration, when the vehicle 1 travels by the motor 330, when the vehicle 1 is rapidly accelerated while traveling by the engine 340, and the like, the power conversion unit 320 converts the power discharged from the assembled batteries 100 into AC power and transforms the power, and supplies the resultant power to the motor 330, which makes it possible to reduce fuel consumed by the engine and to improve fuel efficiency. Further, when the vehicle 1 is decelerated, the motor 330 is caused to operate as a regenerative brake to recover motion energy as power. The power conversion unit 320 converts the power into DC power and transforms the power, and batteries 101 are charged with the resultant power. This makes it possible to prepare next discharge by traveling and acceleration.

### (Configuration of Vehicle Control Apparatus 400)

The vehicle control apparatus 400 controls entire operation of the vehicle 1 while controlling the battery control apparatus 200 and the vehicle driving apparatus 300. The vehicle control apparatus 400 includes a vehicle control management unit 410 controlling the battery control apparatus 200 and the vehicle driving apparatus 300, and a vehicle storage unit 420 storing information on the vehicle 1.

The vehicle control management unit 410 controls the relay 310, the power conversion unit 320, the motor 330, the engine 340, and the like. There are a variety of control contents of the vehicle control management unit 410. As an example, there is determination of driving force distribution for the motor 330 and the engine 340 based on predetermined information. Examples of the predetermined information include information on each of the batteries 101 input from the battery control apparatus 200, information input from the power conversion unit 320, information input from the motor 330, and information input from the engine 340. The information on each of the batteries 101 is, for example, a state of charge (SOC).

The vehicle control management unit 410 develops driving force distribution for the engine 340 and the motor 330, and energy management plan relating to charge/discharge of the assembled batteries 100 by referring to information such as a power limit value and the SOC from an assembled-battery control management unit 230. Further, the vehicle control management unit 410 outputs a control command calculated based on the driving force distribution and the energy management plan, to the power conversion unit 320, thereby controlling a load or a power generation amount. By the calculation, the vehicle control management unit 410 can prevent energy loss caused by acceleration/deceleration of an automobile, namely, energy waste such as engine startup in an SOC insufficient state and regenerative invalidation in an SOC excessive state. As a result, fuel efficiency is improved, and a discharge amount of carbon dioxide can be reduced.

The vehicle storage unit 420 stores information about the vehicle 1. The stored information is data used for control of the vehicle control apparatus 400. The information includes data about the driving force distribution for the motor 330 and the engine 340, and the like.

### (Configuration of Assembled Battery 100)

The assembled batteries 100 supply power to the motor 330 through the relay 310 and the power conversion unit 320. One or a plurality of assembled batteries 100 are provided in the vehicle 1. The plurality of assembled batteries 100 are electrically coupled in series. Each of the assembled batteries 100 includes one or a plurality of batteries 101. The plurality of batteries 101 are electrically coupled in series. A lithium ion secondary battery is used for each of the batteries 101. Each of the batteries 101 may be a nickel hydride battery, a lead battery, an all-solid-state battery, or the like.

### (Configuration of Battery Control Apparatus 200)

The battery control apparatus 200 controls the batteries 101 of the assembled batteries 100 and the like. The battery control apparatus 200 includes a battery management unit 210 managing states of the batteries 101 and the like, a detection unit 220 detecting the states of the batteries 101 and the like, an assembled-battery storage unit 240 storing information on the batteries 101 and the like, and the assembled-battery control management unit 230 controlling and managing the assembled batteries 100.

The battery control apparatus 200 is configured as a battery management system (BMS). A plurality of functional blocks (such as assembled-battery control management unit 230) of the battery control apparatus 200 are embodied, for example, when a microcomputer, a controller, a processor, or the like mounted on an integrated circuit substrate executes programs stored in a memory. Note that each of the functional blocks may be realized by dedicated hardware.

The battery control apparatus 200 appropriately calculates the SOC of each of the batteries 101, and a power limit value that is a limit value for charge and discharge. If a resistance value of any of the batteries 101 is specifically increased, the battery control apparatus 200 further appropriately limit the power limit value. In a case where the resistance value of the battery 101 is recovered, the battery control apparatus 200 eases limitation of the power limit value. The case where the resistance value of the battery 101 is specifically increased indicates a case where the resistance value of the battery 101 is temporarily increased and the resistance value may be recovered by rest for a long time of several days, like a case where the battery is continuously used in a high-load state.

The battery control apparatus 200 outputs the power limit value calculated as described above to the vehicle control apparatus 400. The vehicle control apparatus 400 controls input/output of the motor 330 based on the information, thereby realizing safe charge/discharge of the assembled batteries 100, and preventing the resistance values of the batteries 101 from being specifically increased.

### (Battery Management Unit 210)

The battery management unit 210 manages the states of the batteries 101 and the like. The battery management unit 210 includes one or a plurality of battery control units 211. One battery control unit 211 corresponds to one or a plurality of assembled batteries 100. Each of the battery control units 211 performs measurement of voltages of the batteries 101 included in each of the corresponding assembled batteries 100, and state control such as balancing.

### (Detection Unit 220)

The detection unit 220 detects states of a current, a voltage, a temperature, and the like of each of the batteries 101 and the like. The detection unit 220 includes a current detection unit 221, a voltage detection unit 222, and a temperature detection unit 223.

The current detection unit 221 detects a current value of each of the batteries 101, and current values of the plurality of batteries 101 coupled in series or the like. In a case where the batteries 101 are coupled in series, a current value by one current detection unit 221 provided for one series may be used as the current value of each of the batteries 101. The current detection unit 221 includes a current sensor and electric wires. The current sensor is electrically coupled to components of the assembled batteries 100 in order to detect currents flowing through the batteries 101. Examples of the components of the assembled batteries 100 include a busbar. The current detection unit 221 outputs the detected current values to the assembled-battery control management unit 230. As a result, the assembled-battery control management unit 230 can perform calculation of the SOC and the deterioration state of each of the batteries 101, the power limit value, and the like, and detection of overcurrent and the like.

The voltage detection unit 222 detects voltage values of the plurality of assembled batteries 100 coupled in series or the like. The voltage detection unit 222 includes a voltage sensor and electric wires. The voltage sensor is electrically coupled to components such as a busbar in order to detect the voltages of one or the plurality of assembled batteries 100 coupled in series. The voltage detection unit 222 outputs the detected voltage values to the assembled-battery control management unit 230. As a result, the assembled-battery control management unit 230 can protect the assembled batteries 100, and calculate of the SOC and the like.

The temperature detection unit 223 detects temperatures of the batteries 101, environment temperatures of the assembled batteries 100, and the like. The temperature detection unit 223 includes temperature sensors and electric wires. The temperature sensors are attached to the batteries 101 and the assembled batteries 100. The temperature detection unit 223 outputs the detected temperatures to the assembled-battery control management unit 230. As a result, the assembled-battery control management unit 230 can calculate a maximum temperature, an average temperature, and a minimum temperature of the batteries 101, and detect excessive temperature increase and the like. Further, when battery characteristics used for calculation of the SOC and the like are corrected based on the temperatures, calculation accuracy of the SOC and the like can be improved.

The detection unit 220 is not limited to the above-described configuration. The detection unit 220 may has a configuration including a communication detection unit that detects a communication state of the battery management unit 210. In a case of such a configuration, in a case where a communication error occurs in the battery management unit 210, the communication detection unit notifies the assembled-battery control management unit 230 of a communication failure of the battery management unit 210. A part or a whole of the detection unit 220 may be configured by the battery control unit 211 of the battery management unit 210.

In addition, the current detection unit 221, the voltage detection unit 222, and the temperature detection unit 223 may diagnose the batteries 101 and the assembled batteries 100, and output results of the diagnosis and detection values to the assembled-battery control management unit 230 and the vehicle control management unit 410. With such a configuration, measurement values and diagnosis results can be output to the vehicle control management unit 410 even in a case where the assembled-battery control management unit 230 fails. The detection unit 220 of the battery control apparatus 200 may be provided in each of the assembled batteries 100.

### (Assembled-Battery Control Management Unit 230)

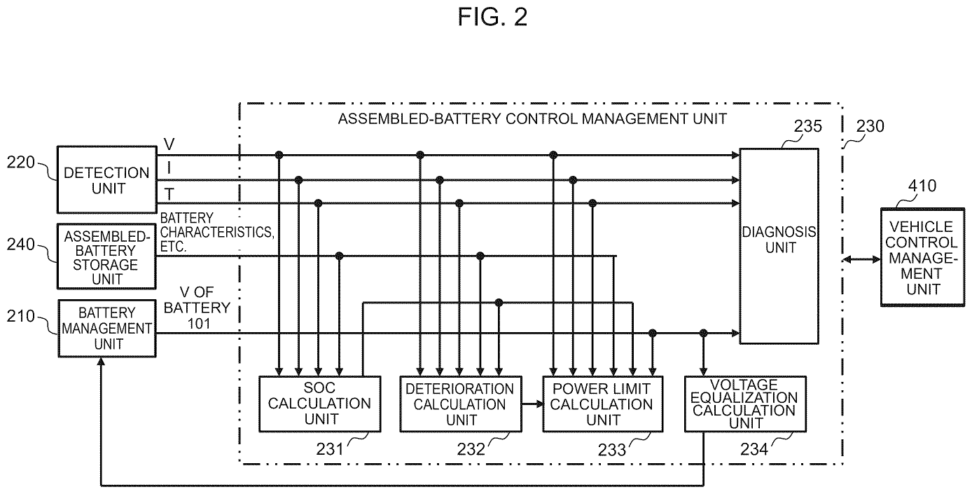

The assembled-battery control management unit 230 is described with reference to FIG. 2. The assembled-battery control management unit 230 performs calculation for suitably controlling charge/discharge of the assembled batteries 100 and calculation for diagnosis and protection, based on information input from the detection unit 220 and the battery management unit 210, and a current limit value and battery characteristics of the batteries 101 previously stored in the assembled-battery storage unit 240. Examples of the calculation for suitable control include calculation of the state of charge (SOC) of each of the batteries 101, calculation of a state of health based on resistance (SOHR), and calculation of a limit value of charge/discharge power for each of the batteries 101. Examples of the calculation for diagnosis and protection include calculation for performing voltage equalization control of each of the batteries 101, overcharge diagnosis, overdischarge diagnosis, and soundness diagnosis of the detection unit 220. To realize the calculation, the assembled-battery control management unit 230 includes an SOC calculation unit 231, a deterioration calculation unit 232, a power limit calculation unit 233, a voltage equalization calculation unit 234, a diagnosis unit 235, and the like. The assembled-battery control management unit 230 calculates the states and the characteristics of the batteries from the measurement values and the characteristics of the assembled batteries 100 and the batteries 101 acquired from the detection unit 220, the assembled-battery storage unit 240, and the battery control units 211, and outputs calculation results and commands based on the calculation results to the battery management unit 210, the battery control units 211, and the vehicle control management unit 410.

The SOHR calculated by the deterioration calculation unit 232 is calculated as a ratio of a current resistance value to an initial resistance value based on at least any of data input from the detection unit 220 and the battery management unit 210, and the battery characteristics of the batteries previously stored in the assembled-battery storage unit 240. A current flowing through each of the batteries 101 is inversely proportional to the resistance value. Therefore, the form of such a ratio is suitable as an index indicating the deterioration state of the battery.

The power limit value calculated by the power limit calculation unit 233 is calculated as an upper limit of a suitably chargeable/dischargeable power value of each of the batteries 101 and the assembled batteries 100, based on data input from the detection unit 220 and the battery management unit 210, the SOC calculated by the SOC calculation unit 231, the SOHR calculated by the deterioration calculation unit 232, and input from the assembled-battery storage unit 240 and the like. Examples of a condition of the suitably chargeable/dischargeable power value include a condition that a current value does not exceed an upper limit current value determined for each member, a condition that a voltage does not exceed upper/lower limit voltages of each of the batteries 101 by charge/discharge, a condition that a temperature of each of the batteries 101 and members does not exceed an upper limit value, a condition that the SOC is within a predetermined range, a condition that a lifetime of each of the batteries 101 can be secured, and a condition that, in a case where abnormality is found in any of the batteries 101, the power value rapidly becomes zero. The calculated power limit value is output to the vehicle control management unit 410, and is used for control of the charge/discharge, energy management, and the like.

As described above, by adopting a hierarchical structure in which data on the plurality of batteries 101 is collected to the battery management unit 210, and the data is further collected to the assembled-battery control management unit 230, reduction of signal lines necessary for collection, simplification of the structure, and flexibility securement to the number of batteries 101 are performable, which makes it possible to realize a large-size secondary battery including a large number of batteries.

### (Assembled-Battery Storage Unit 240)

The assembled-battery storage unit 240 stores histories, states, statistics, characteristics, and the like of each of the batteries 101. The histories are histories of, for example, the current value, the voltage value, and the temperature of each of the batteries 101. The states are, for example, the SOC, the current value, the voltage value, the internal resistance value, and the temperature of each of the batteries 101. The statistics are, for example, an integrated value and an average value of the current, and the number of detection times of abnormal value. The characteristics are, for example, internal resistance characteristics, a full-charge capacity, polarization resistance characteristics, deterioration characteristics, individual difference, and an SOC table of each of the batteries 101. The SOC table is a table recording the correspondence relationship between the SOC and an OCV. In the present embodiment, the assembled-battery storage unit 240 is provided separately from the assembled-battery control management unit 230, but may be provided inside the battery management unit 210 or inside the assembled-battery control management unit 230. Further, the histories, the statistics, and the like may be stored in the vehicle control management unit 410, the vehicle storage unit 420, or the like outside the battery control apparatus 200.

### (Power Limit Calculation Unit 233)

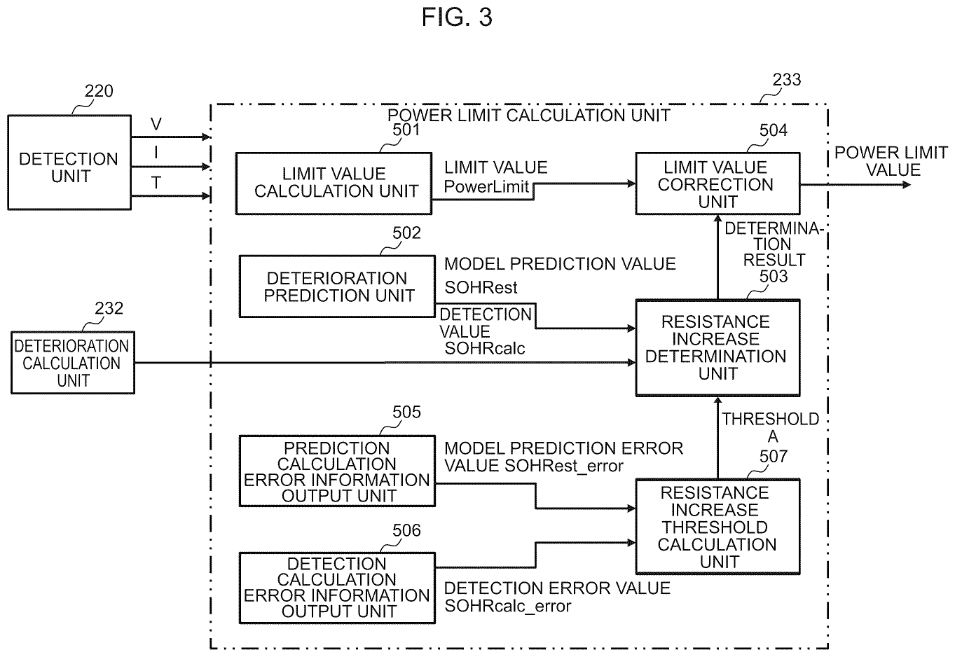

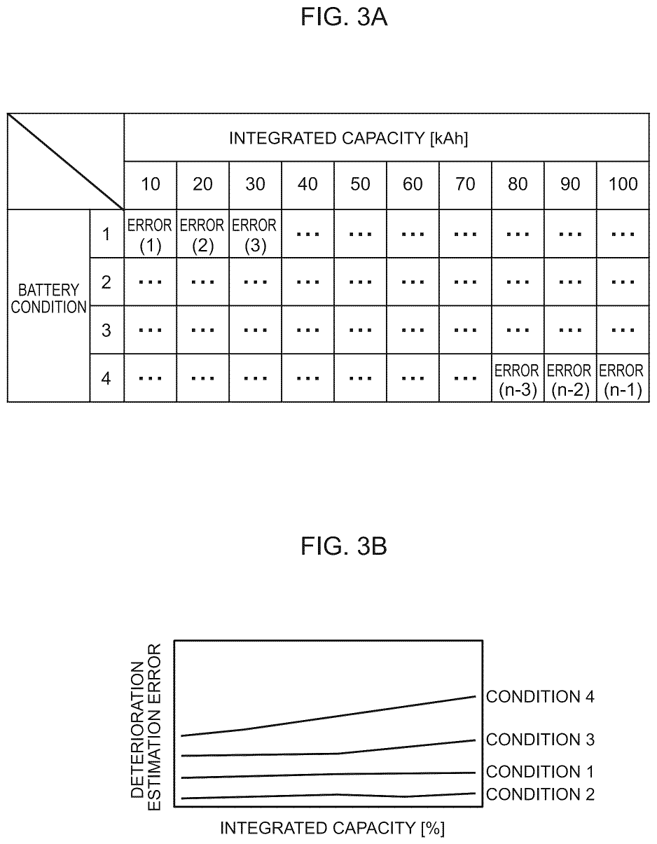

FIG. 3 illustrates a configuration of the power limit calculation unit 233. The power limit calculation unit 233 includes a limit value calculation unit 501, a deterioration prediction unit 502, a resistance increase determination unit 503, and a limit value correction unit 504. In addition, the power limit calculation unit 233 may include a prediction calculation error information output unit 505, a detection calculation error information output unit 506, and a resistance increase threshold calculation unit 507.

### (Limit Value Calculation Unit 501)

The limit value calculation unit 501 calculates the upper limit of the safely chargeable/dischargeable power value of each of the batteries 101 and the assembled batteries 100, based on data input from the detection unit 220 and the battery management unit 210, the SOC calculated by the SOC calculation unit 231, the SOHR calculated by the deterioration calculation unit 232, and input from the assembled-battery storage unit 240 and the like, and outputs the upper limit as a limit value. Examples of a condition of the safely chargeable/dischargeable power value include a condition that a current value does not exceed an upper limit current value determined for each member, a condition that a voltage does not exceed upper/lower limit voltages of each of the batteries 101 by charge/discharge, a condition that a temperature of each of the batteries 101 and members does not exceed an upper limit value, a condition that the SOC is within a predetermined range, and a condition that, in a case where abnormality is found in any of the batteries 101, the power value rapidly becomes zero. The characteristics of the limit value may be different depending on a purpose of use of the limit value. Therefore, a plurality of types of limit values may be output as necessary. Further, limit value may be different between charge and discharge.

### (Deterioration Prediction Unit 502)

The deterioration prediction unit 502 predicts the deterioration state of each of the batteries 101 based on a deterioration model of the batteries 101. The deterioration model of the batteries 101 simulates deterioration of the batteries 101 based on data on a use current, a voltage range, a temperature, an energization frequency, a usage of electricity, and the like of the batteries 101. The deterioration model is, for example, a mathematical model (multivariate deterioration prediction expression, etc.) or a map relating to a deterioration condition.

The deterioration model is configured based on data on the batteries 101 acquired by the week or by the month, and is to estimate deterioration variation until a required lifetime of the batteries applied to the vehicle. It is assumed that, in the deterioration model, rapid resistance increase of the batteries 101 does not occur. In other words, the deterioration model is a model of relatively-moderate deterioration transition of the batteries 101.

The deterioration prediction unit 502 converts information on the batteries 101 into internal deterioration parameters that are predetermined parameters for deterioration prediction. The deterioration prediction unit 502 calculates a prediction value of a deterioration degree of the batteries 101 based on the parameters and the deterioration model. The deterioration prediction unit 502 outputs a model prediction value SOHRest as the prediction value of the deterioration state of each of the batteries 101. Since the model prediction value SOHRest is calculated based on the deterioration model, variation of the model prediction value SOHRest is relatively moderate as with variation of the deterioration model.

### (Calculation of Internal Deterioration Parameter)

The deterioration prediction unit 502 selects data within a predetermined range from the data on the batteries 101 stored in the assembled-battery storage unit 240. The deterioration prediction unit 502 calculates the capacities of the batteries 101, and the internal deterioration parameters corresponding to a deterioration state of an internal resistance as the above-described parameters based on the selected data.

The deterioration prediction unit 502 calculates a charge/discharge end voltage curve that indicates the relationship between the SOC and the charge/discharge end voltage of each of the battery 101, and an OCV curve that indicates the relationship between the SOC and the OCV of each of the batteries 101, for each of a plurality of operating times, based on the voltages of the batteries 101 included in the selected data.

The deterioration prediction unit 502 calculates a resistance curve that indicates the relationship between the soc and the internal resistance of each of the batteries 101 for each of the plurality of operating times based on the charge/discharge end voltage curve, the OCV curve, and the current of the secondary battery indicated in the selected data.

The deterioration prediction unit 502 calculates the internal deterioration parameters of each of the batteries 101 based on the charge/discharge end voltage curve, the OCV curve, and the resistance curve. The internal deterioration parameters of each of the batteries 101 include parameters relating to a capacity of a positive electrode, a capacity of a negative electrode, a resistance of the positive electrode, and a resistance of the negative electrode. The deterioration model may be configured as a deterioration model reflecting the deterioration state of each of the batteries 101 based on physical properties of the positive electrode and the negative electrode of each of the batteries 101.

### (Deterioration Model)

The deterioration model calculates an active material utilization rate of the positive electrode and the negative electrode of each of the batteries 101, and a change amount of resistance deterioration rate based on conditions of the current, the voltage, the temperature, the energization rate, and the like of each of the batteries 101, and the calculated internal deterioration parameters. Further, the SOHR of each of the batteries 101 is predicted along a time series from the active material utilization rate and the change amount of resistance deterioration rate. The deterioration prediction unit 502 can calculate the prediction value of deterioration of each of the batteries 101 while reflecting the state of each of the batteries 101 on the deterioration model with relatively high accuracy.

The deterioration model may be configured to extract a use condition of each of the batteries 101 based on calculation values based on the information relating to the deterioration states of the positive electrode and the negative electrode of each of the batteries 101, and the other configuration members, and the detection value of each of the batteries 101. The deterioration model enables prediction of capacity deterioration and resistance change of each of the batteries 101 based on the use condition of each of the batteries 101. By using various information as described above, prediction accuracy of the SOHR based on the deterioration model is improved, accuracy for detecting specific increase of the resistance value is improved, and accordingly, the lifetime of each of the batteries can be brought close to an expected lifetime. As a result, performance of the batteries is maintained, and energy loss of the automobile can be reduced.

### (Resistance Increase Determination Unit 503)

The resistance increase determination unit 503 differentiates the model prediction value SOHRest output from the deterioration prediction unit 502 and a deterioration calculated value SOHRcalc output from the deterioration calculation unit 232 to calculate (dSOHRest/dt) and (dSOHRcalc/dt) that are variations per unit time. (dSOHRcalc/dt) is equivalent to a deterioration speed (change over time) of each of the batteries 101. On the other hand, (dSOHRest/dt) is equivalent to a deterioration speed of each of the batteries 101 in a case where specific resistance increase does not occur.

In a case where specific resistance increase occurs, (dSOHRcalc/dt) that is an actual measurement value becomes larger than (dSOHRest/dt) that is a model prediction value. Therefore, the resistance increase determination unit 503 calculates a difference 1 [(dSOHRcalc/dt)−(dSOHRest/dt)] between (dSOHRcalc/dt) and (dSOHRest/dt), and compares the difference 1 [(dSOHRcalc/dt)−(dSOHRest/dt)] with a threshold A to determine whether specific resistance increase occurs in each of the batteries 101. In other words, in a case where the difference 1 [(dSOHRcalc/dt)−(dSOHRest/dt)] is a value deviated from the threshold A as an allowable range, the resistance increase determination unit 503 determines a timing when the specific resistance increase of each of the batteries 101 starts.

The threshold A is determined in consideration of a calculation error of the assembled-battery control management unit 230, an estimation width of the deterioration model, and other sensor errors. Providing the threshold A as described above enables the assembled-battery control management unit 230 to suppress specific resistance increase of each of the batteries 101 while preventing output of a load from becoming unstable.

### (Limit Value Correction Unit 504)

The limit value correction unit 504 corrects the limit value of the charge/discharge power for the batteries 101 based on a determination result of the resistance increase determination unit 503. In a case where the resistance increase determination unit 503 determines that the specific resistance increase occurs in the batteries 101, the limit value correction unit 504 corrects the limit value in a direction to reduce the charge/discharge power of the batteries 101.

The limit value correction unit 504 outputs the corrected limit value to the vehicle control management unit 410. The vehicle control management unit 410 controls the load (power conversion unit 320) to limit the charge/discharge power of the batteries 101 based on the corrected limit value.

As described above, in a case where the measurement value and the model prediction value of the resistance increase speed are deviated beyond the threshold A and it is determined that the specific resistance increase occurs, the limit value correction unit 504 reduces the power limit value to reduce the power flowing through the load (power flowing through batteries 101), which makes it possible to suppress the specific resistance increase of the batteries 101 at an early stage.

### (Prediction Calculation Error Information Output Unit 505)

The prediction calculation error information output unit 505 outputs an error that may be included in the calculation result of the model prediction value SOHRest, namely, SOHRest_error, based on the current, the voltage, and the temperature. To output the error, the prediction calculation error information output unit 505 refers to error information illustrated in FIGS. 3A and 3B. FIG. 3A is a map of prediction calculation error information when a low load is applied to the batteries 101, and includes SOHRest error information for each integrated capacity under each of a plurality of battery conditions. FIG. 3B is a graph of the map.

FIGS. 3A and 3B illustrate error information in a deterioration prediction model in an area where a load applied to the batteries 101 is low, namely, in an area where specific resistance increase does not occur in the batteries 101. Characteristics of the error information illustrated in FIGS. 3A and 3B are configured such that an error of the model prediction value SOHRest is changed with increase in an integrated usage of the batteries 101. Change of the error of the model prediction value SOHRest is configured so as to correlate with conditions of an operation range (ASOC) of each of the batteries 101, the current value, the temperature, and the like. Therefore, even in the case of the deterioration model in which the error of the deterioration estimated value is varied by increase in the integrated usage of the batteries 101, namely, increase of deterioration of the batteries 101, the error that may be included in the output of the model can be estimated.

### (Detection Calculation Error Information Output Unit 506)

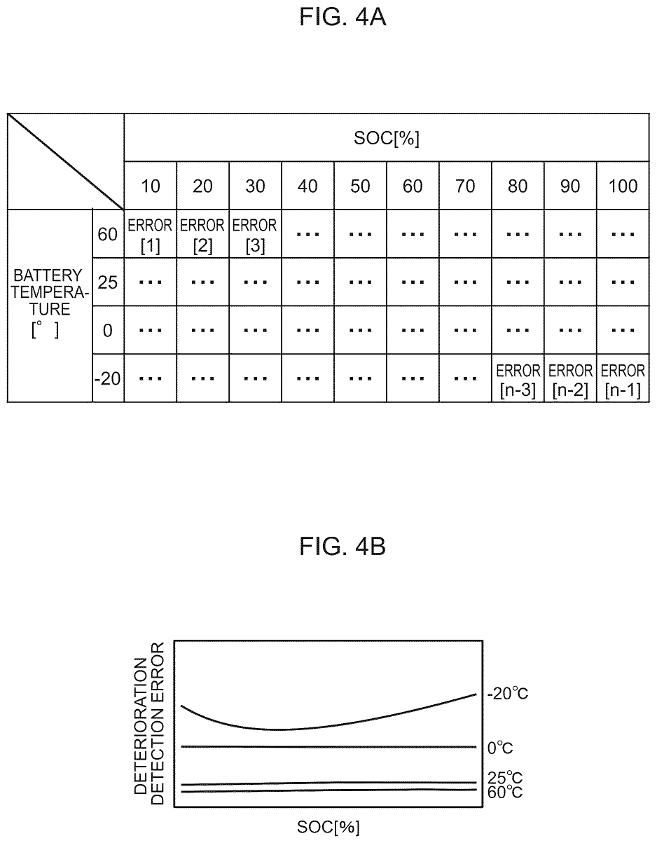

The detection calculation error information output unit 506 outputs an error that may be included in the detection value SOHRcalc output from the deterioration calculation unit 232, namely, SOHRcalc_error based on the temperature and the SOC. The error includes, for example, an error of calculation algorithm, a detection error of current/voltage/temperature, and/or a conversion error. To output the error, the detection calculation error information output unit 506 refers to error information illustrated in FIGS. 4A and 4B. FIG. 4A is a map of detection value error information when a low load is applied to the batteries 101, and includes detection value error information for each SOC at each of a plurality of battery temperatures. FIG. 4B is a graph of the map. In a case where the error of SOHRcalc depends on the current, the voltage, or the like, dimensions of the current value, the voltage value, and the like may be added to the map illustrated in FIG. 4A to configure a multidimensional map.

The calculation error of the detection value SOHRcalc is increased/decreased based on the SOC dependency of the SOHR, temperature dependency of various kinds of sensors, and the like. In this configuration, the SOC, the temperature, and the like are used as inputs of the error information map. Therefore, even when the detection value SOHRcalc has the above-described characteristics, the error that may be included in the detection value can be estimated.

### (Resistance Increase Threshold Calculation Unit 507)

One form of the resistance increase threshold calculation unit 507 outputs a large threshold A when the error is large, and outputs a small threshold A when the error is small, to the resistance increase determination unit 503 based on the model prediction error SOHRest_error and the detection error SOHRcalc_error. Such a configuration enables output of the threshold A corresponding to the error of the detection value SOHRcalc and the error of the model prediction value SOHRest, which makes it possible to more strictly determine occurrence of the specific resistance increase.

In another form of the resistance increase threshold calculation unit 507, the threshold A calculated from the detected SOHR by using an expression (1) is output to the resistance increase determination unit 503.

$$A ∝ SOHR ( t , T , I ) \qquad ( 1 )$$

The SOHR is increased by the current integrated capacity and the like. Further, most of the factors are common to the predicted calculation error and the detected calculation error, and the SOHR is usable as a substitute for the error calculation. As described above, calculating the threshold A by using the SOHR makes it possible to reduce the map and the memory necessary for calculation, and the calculation time.

### (Action of Battery Control Apparatus 200)

Next, action of the battery control apparatus 200 is described.

### (Increase of Resistance Value of Battery 101)

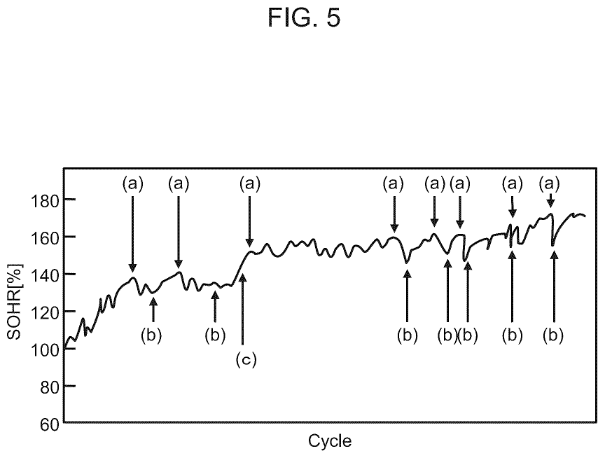

An aspect of increase of the resistance value of each battery 101 is described. FIG. 5 is a graph illustrating a specific resistance increase phenomenon caused by continuous use of a secondary battery such as a lithium ion battery under a high load. FIG. 5 indicates an increase degree of the resistance to the number of cycles in a case where a cycle test was performed on the lithium ion battery in a high-load pattern. As an index for determining the specific resistance increase, the SOHR that indicates an increase percentage (increase rate) of the resistance value to the initial state was used.

As illustrated in FIG. 5, after energization is stopped for a long time from a time point (a) when the index is increased, the SOHR is reduced (b); however, when a high-load charge/discharge cycle is resumed, the resistance value (SOHR) is increased again, and deterioration of the battery progresses at an accelerated rate. If detection of the increase in index is delayed, and usage under the high load is continued, the battery cannot be recovered from deterioration. If the battery is rested, the resistance is increased immediately after the high-load cycle operation of the battery starts, and deterioration of the battery is cumulatively accelerated (c). To avoid such a situation, the battery control apparatus 200 reduces the load by using the power limit value and the like.

### (Determination of Specific Resistance Increase)

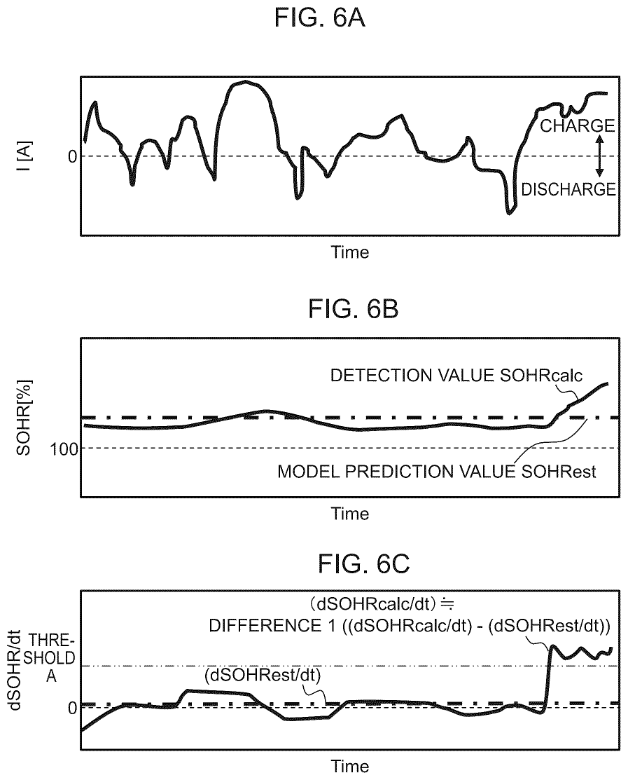

A first example of a method of determining the specific resistance increase in each battery 101 is described with reference to FIGS. 6A, 6B, and 6C. FIG. 6A is a graph illustrating a current value of a certain battery 101 among the plurality of batteries 101. FIG. 6B is a graph illustrating change over time of each of the model prediction value SOHRest and the detection value SOHRcalc of the battery 101. FIG. 6C is a graph illustrating variation of each of a time rate of change (dSOHRest/dt) of the model prediction value SOHRest and a time rate of change (dSOHRcalc/dt) of the detection value SOHRcalc, and the difference 1 ((dSOHRcalc/dt)−(dSOHRest/dt)) therebetween. The time rate of change of the detection value SOHRcalc is overlapped with the difference 1 because the time rate of change of the detection value SOHRcalc is substantially equal to the difference 1. A lateral axis in FIGS. 6A, 6B, and 6C is a time axis of the same scale. In the following, a lateral axis in a plurality of relating drawings is the time axis of the same scale.

The current value of the battery 101 is the current value in a state where the plurality of batteries 101 are coupled in series. The current value of the battery 101 is varied over time. In the following description, the current value of the battery 101 in a direction in which the battery 101 is charged is positive.

In FIG. 6B, the detection value SOHRcalc is increased due to the specific increase of the resistance value of the battery 101. On the other hand, the deterioration degree of the deterioration model is little varied by energization of the battery 101 for a short time of about several hours. Therefore, the model prediction value SOHRest is illustrated as a substantially flat line.

In FIG. 6B, in a case where the detection value SOHRcalc and the model prediction value SOHRest are compared, the deterioration degree of the battery 101 can be known to some extent. However, even when the detection value SOHRcalc and the model prediction value SOHRest are directly compared, it is not easy to determine whether the specific increase of the resistance value of the battery 101 is occurring due to continuous use of the battery 101 under a high load. Therefore, the resistance increase determination unit 503 determines whether the resistance value of the battery 101 is specifically increasing, based on the method illustrated in FIG. 6C.

FIG. 6C illustrates a change rate per time of each of the detection value SOHRcalc and the model prediction value SOHRest of the battery 101. The deterioration calculation unit 232 calculates the change rate of the detection value SOHRcalc. The change rate of the detection value SOHRcalc is calculated as (dSOHRcalc/dt) by time-differentiating the detection value SOHRcalc.

The deterioration prediction unit 502 calculates the change rate of the model prediction value SOHRest. The change rate of the model prediction value SOHRest is calculated as (dSOHRest/dt) by time-differentiating the model prediction value SOHRest. In a case where (dSOHRcalc/dt) is largely deviated from (dSOHRest/dt), the resistance increase determination unit 503 determines that specific increase of the resistance value has occurred (high-load resistance increase determination). In other words, as illustrated in FIG. 6C, in a case where the difference 1 [(dSOHRcalc/dt)−(dSOHRest/dt)] that is a difference of time differentiation is positive and exceeds the threshold A, the resistance increase determination unit 503 determines that specific increase of the resistance value has occurred in the battery 101.

In response to the determination, the limit value correction unit 504 updates, corrects, or changes the limit value so as to reduce the charge/discharge power of the battery 101 in order to suppress resistance increase of the battery 101. The limit value correction unit 504 may not reduce the limit value at a stroke, and may gradually change the limit value. By moderating change of the limit value, it is possible to prevent control of the load or a power generation amount from becoming unstable, which makes it possible to improve ride quality of the vehicle.

The resistance increase threshold calculation unit 507 determines the threshold A in consideration of an allowable error range, a calculation error in the deterioration calculation, a calculation error in the model prediction value calculation, an estimation width of the deterioration model, a sensor error, and the like in order to prevent erroneous determination of the high-load resistance increase determination. The resistance increase threshold calculation unit 507 desirably sets the threshold A within a range where ON/OFF determination of the high-load resistance is not excessively frequently switched. A plurality of thresholds A may be set based on the conditions and the power limit value. As a first example of the threshold A, the threshold A may be set relatively large.

When the resistance increase determination unit 503 determines that the difference 1 exceeds the threshold A, the limit value correction unit 504 corrects the limit value of the charge/discharge power for the battery 101 such that relatively strict power limitation is applied to the battery 101. As a result, the current limit of the battery 101 is realized based on characteristics of the resistance value of the battery 101.

As a second example of the threshold A, the threshold A may be set relatively small. In the second example, when the resistance increase determination unit 503 determines that the difference 1 exceeds the threshold A, the limit value correction unit 504 corrects the limit value such that power limitation relatively gentler than the first example is applied to the battery 101.

As a third example of the threshold A, the threshold A may be changed based on the deterioration degree of the battery 101. The third example is useful in a case where the increase rate of the resistance value of the battery 101 is affected by the SOHR. The threshold A may be determined as, for example, a function of the SOHR to the time, the temperature, and the current as expressed by the above-described expression (1).

When the threshold is provided as described above, the battery control can be performed so as to suppress resistance increase of the battery 101 while preventing the output of the load from becoming unstable.

### (Correction of Limit Value)

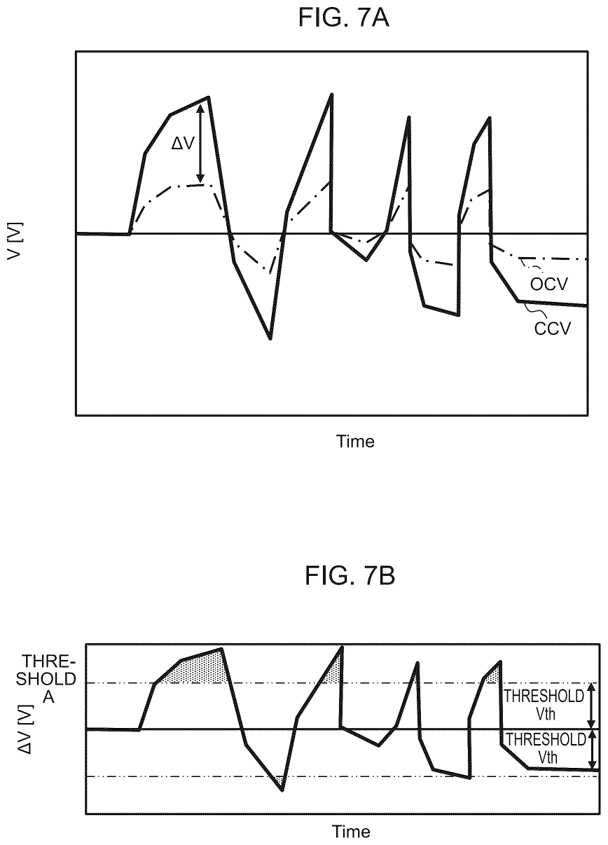

As illustrated in FIGS. 7A and 7B, the limit value correction unit 504 can correct the limit value of the current or the power for the battery 101 based on, for example, a ΔV limiting method. The ΔV limiting method is a method for setting the limit value such that ΔV is within a predetermined threshold Vth, and ΔV is a difference between an open circuit voltage (OCV) and a closed circuit voltage (CCV). The OCV is a voltage in a no-load state where no load is applied to the battery 101. In other words, the OCV is a voltage (open circuit voltage) in a state where no current flows through an electric apparatus from the battery 101.

The CCV is an actual inter-terminal voltage of the battery 101. When the battery 101 is left for a long time in a state where no current flows through the battery 101, the CCV and the OCV are coincident with each other. On the other hand, when the current flows through the battery 101, the CCV is changed by the voltage generated by the internal resistance of the battery 101 and a polarization voltage generated by the current, and the CCV and the OCV are not coincident with each other. The CCV is increased when the battery 101 is charged, whereas the CCV is reduced when the battery 101 is discharged.

As described above, the change amount of the CCV is increased with increase of the resistance value, and accordingly ΔV is increased with increase of the resistance value. Therefore, in a case where the specific increase of the resistance value occurs, ΔV also tends to be a specifically large value. In the ΔV limiting method, charge/discharge is limited such that ΔV becomes equal to or smaller than a predetermined value. Therefore, in a case where such a large ΔV occurs, strict power limit value is set, the load is reduced, and the battery can be recovered. In the present embodiment, in the case where the resistance increase determination unit 503 determines that the specific increase of the resistance value occurs, the limit value correction unit 504 reduces the value of the threshold Vth. As a result, the limit value correction unit 504 can reduce the limit value at an early stage, the specific increase of the resistance value is eliminated at an initial stage, and rapid deterioration of the battery can be prevented.

### (Method of Controlling Battery 101)

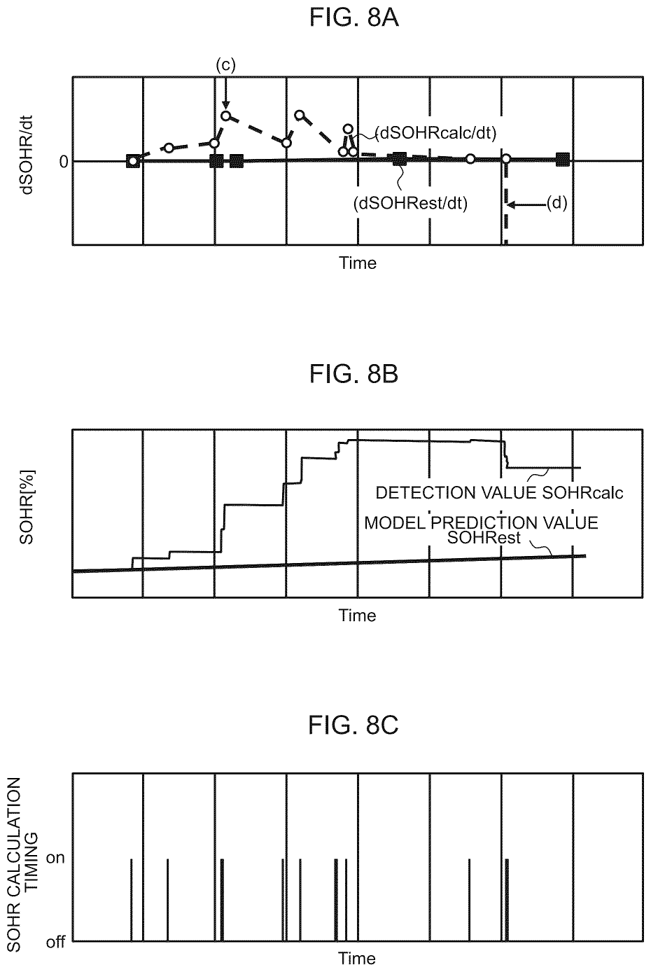

The method of controlling the battery 101 reflecting increase of the resistance value of the battery 101, performed by the battery control apparatus 200 is described with reference to FIGS. 8A to 8C. The deterioration calculation unit 232 calculates the detection value SOHRcalc at predetermined time points, for example, at timings (FIG. 8C) when a condition suitable for deterioration calculation is established, with respect to an energization current optionally switched. Examples of such timings include a timing when the energization current is instantaneously largely changed. At this time, as illustrated in FIG. 8B, the detection value SOHRcalc is varied stepwise at the respective timings. When the calculation is performed at the timings when the energization current is instantaneously largely changed, calculation accuracy is improved. Note that the calculation timings may be equal and regular timings. This improves real-time property of the detection value SOHRcalc.

As illustrated in FIG. 8A, the resistance increase determination unit 503 calculates (dSOHRcalc/dt) and (dSOHRest/dt) in a time-series manner. The deterioration model as a base of calculation of the model prediction value SOHRest is a model of deterioration transition under a condition that the rapid resistance increase does not occur as described above. Therefore, variation of the model prediction value SOHRest is gentle. In contrast, the detection value SOHRcalc is noticeably varied at each calculation timing based on charge/discharge of the battery.

The reason why (dSOHRcalc/dt) is increased at a stroke at (c) in FIG. 8A is because the high load is continued immediately before the increase, and as a result, specific increase of the resistance value occurs, and the detection value SOHRcalc is increased in a short time. On the other hand, the reason why (dSOHRcalc/dt) is reduced at a stroke at (d) in FIG. 8A is because, a period when energization to the battery is stopped or suppressed is present immediately before the reduction, and as a result, the battery is recovered from the state where the specific increase of the resistance value occurs, and the detection value SOHRcalc is reduced at a stroke.

(Recovery from Increase of Resistance Value of Battery 101)

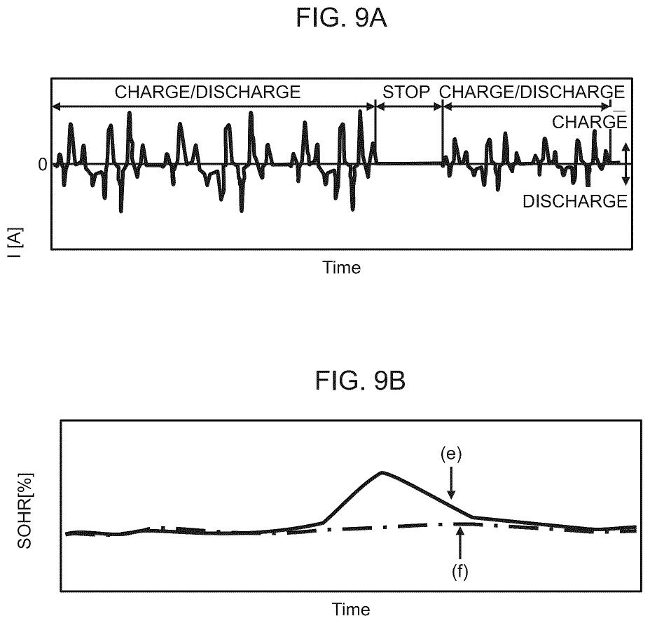

Recovery from increase of the resistance value of the battery 101 by the battery control apparatus 200 is described by comparing the detection value SOHRcalc (FIG. 9B) and change of the current of the battery 101 (FIG. 9A) with reference to FIGS. 9A and 9B. When the resistance increase determination unit 503 determines that the specific resistance increase occurs in the battery 101, the limit value correction unit 504 corrects the limit value in order to eliminate the specific resistance increase. As a result, a charge/discharge stop period is present between two charge/discharge periods.

Therefore, even when the detection value SOHRcalc is remarkably increased during high-load operation of the battery control apparatus 200, the detection value SOHRcalc starts to return to the value before the increase at a stroke (e). In addition, since the assembled-battery control management unit 230 stops charge/discharge at an early stage at which the detection value SOHRcalc starts to increase, irreversible deterioration is prevented, and the detection value SOHRcalc becomes substantially equal to the value before the specific resistance increase occurs (f).

### Second Example of Method of Determining Increase of Resistance Value of Battery 101

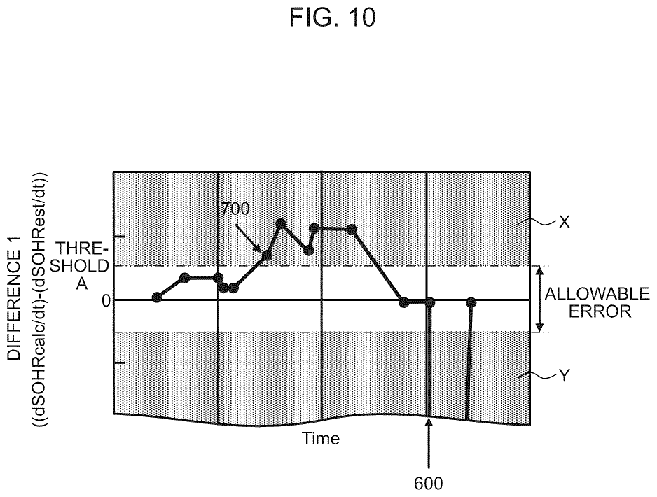

A second example of the method of determining the specific resistance increase of the battery 101, performed by the battery control apparatus 200 is described with reference to FIG. 10. When the existing limiting process (FIG. 9A) is performed, the change rate (dSOHRcalc/dt) of the SOHRcalc is reduced at a stroke (600 in FIG. 10). Using the fact makes it possible to realize auxiliary determination for the high-load resistance increase determination.

In a case where the difference 1 [(dSOHRcalc/dt)−(dSOHRest/dt)] exceeds the threshold A and reaches an area X illustrated in FIG. 10, the resistance increase determination unit 503 determines that the specific resistance increase starts (700). On the other hand, when the charge/discharge power of the battery 101 is limited, and the battery is recovered from the specific resistance increase, the difference 1 rapidly reaches an area Y through an allowable error (threshold A) from the area X at an initial stage (600). Therefore, the resistance increase determination unit 503 can reconfirm that the battery has been in the specific resistance increase state as a result. In other words, the assembled-battery control management unit 230 can realize the auxiliary determination of the high-load resistance increase determination.

The auxiliary determinant can be used to determine whether the specific resistance increase has been eliminated. More specifically, in a case where the auxiliary determination is established once, and then the difference 1 returns to the allowable error range (700), the assembled-battery control management unit 230 can determine that the battery has been recovered from the specific resistance increase. As a result, the assembled-battery control management unit 230 can determine whether the power limit value can be increased to the value before the high-load resistance increase determination. In addition, the determination may be based on a condition that the difference 1 is equal to or larger than zero and returns to a value smaller than a predetermined threshold. By setting such a determination condition, it is possible to more surely determine recovery of the battery.

### (Flowchart of Control Method Performed by Battery Control Apparatus 200)

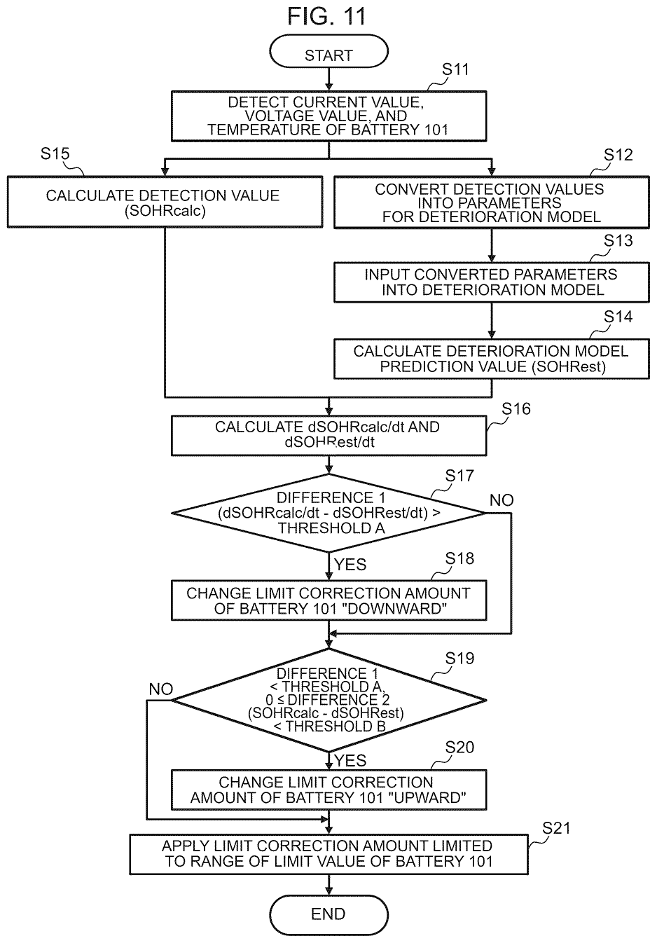

A processor of a microcomputer repeatedly performs a flowchart illustrated in FIG. 11 at each predetermined timing based on programs recorded in a memory. The flowchart is described with reference to the block diagrams illustrated in FIG. 1, FIG. 2, and FIG. 3.

In step S11, the detection unit 220 detects the current value, the voltage value, and the temperature of the battery 101, and proceeds to step S12 and step S15. In step S12, the deterioration prediction unit 502 converts detection values of the voltage V, the current I, and the temperature T of the battery 101 into parameters for the deterioration model, and proceeds to step S13.

In step S13, the deterioration prediction unit 502 inputs the parameters converted in step S12 to the deterioration model, and proceeds to step S14. In step S14, the deterioration prediction unit 502 calculates the model prediction value SOHRest based on the deterioration model in step S13, and proceeds to step S16. In step S15, the deterioration calculation unit 232 calculates the detection value SOHRcalc, and proceeds to step S16.

In step S16, the resistance increase determination unit 503 differentiates the detection value SOHRcalc to calculate dSOHRcalc/dt. In addition, the resistance increase determination unit 503 differentiates the model prediction value SOHRest to calculate dSOHRest/dt. Thereafter, the resistance increase determination unit 503 proceeds to step S17.

In step S17, the resistance increase determination unit 503 compares the difference 1 [(dSOHRcalc/dt)−(dSOHRest/dt)] with the threshold A. In a case where the difference 1 is larger than the threshold A (step S17: Yes), the resistance increase determination unit 503 determines that specific resistance increase occurs in the battery 101, and the resistance increase determination unit 503 proceeds to step S18.

In contrast, in step S17, in a case where the difference 1 is equal to the threshold A (NO) or in a case where the difference is equal to or smaller than the threshold A (NO), the resistance increase determination unit 503 determines that specific resistance increase does not occur in the battery 101. The resistance increase determination unit 503 proceeds to step S21.

In step S18, the limit value correction unit 504 corrects downward the correction amount used for change of the limit value of the current or the power for the battery 101, and proceeds to step S19. By reducing the correction amount, the load can be reduced, and the specific increase of the resistance value can be suppressed.

In step S19, the resistance increase determination unit 503 compares the difference 1 with the threshold A. Further, the resistance increase determination unit 503 compares a difference 2 [(detection value SOCRcalc)−(model prediction value SOCRest)] with a threshold B. In a case where the difference 1 is smaller than the threshold A and the difference 2 is equal to or larger than zero and smaller than the threshold B (step S19: Yes), the resistance increase determination unit 503 determines that the specific resistance increase of the battery 101 is eliminated in step S18. Thereafter, the resistance increase determination unit 503 proceeds to step S20.

In contrast, in step S19, in a case where the difference 1 is equal to or larger than the threshold A, or in a case where the difference 2 is smaller than zero or equal to or larger than the threshold B, the resistance increase determination unit 503 determines that the specific resistance increase of the battery 101 is not yet eliminated, and proceeds to step S21 while the limit value of the current or the power for the battery 101 is still limited. In other words, the resistance increase determination unit 503 and the limit value correction unit 504 continue limitation until the battery is recovered from the specific resistance increase state, and the value becomes close to the model prediction value SOHRest that is an original value after limitation of the battery 101 (step S18).

In step S20, the limit value correction unit 504 corrects the correction amount upward (in moderating direction), and proceeds to step S21. By correcting the correction amount upward, the current value and the voltage value of the battery 101 come close to values in a normal state in a case where the battery 101 is recovered from the specific resistance increase state.

In step S21, limitation to reduce the current and the power is performed based on the correction amount. Such limitation includes, in addition to direct limitation of the current and the power, effective current limitation and limitation of ΔV. At this time, the current and the power are prevented from becoming equal to or larger than the limit values output from the limit value calculation unit 501 even though the current and the power as the limitation result are maximum. Likewise, the current and the power are prevented from becoming smaller than zero.

By performing such a flow, the assembled-battery control management unit 230 more efficiently drives the load by reducing the output suppression period while suppressing deterioration of the batteries. As a result, energy can be effectively utilized.

### (Effects by Method of Controlling Battery 101 by Battery Control Apparatus 200)

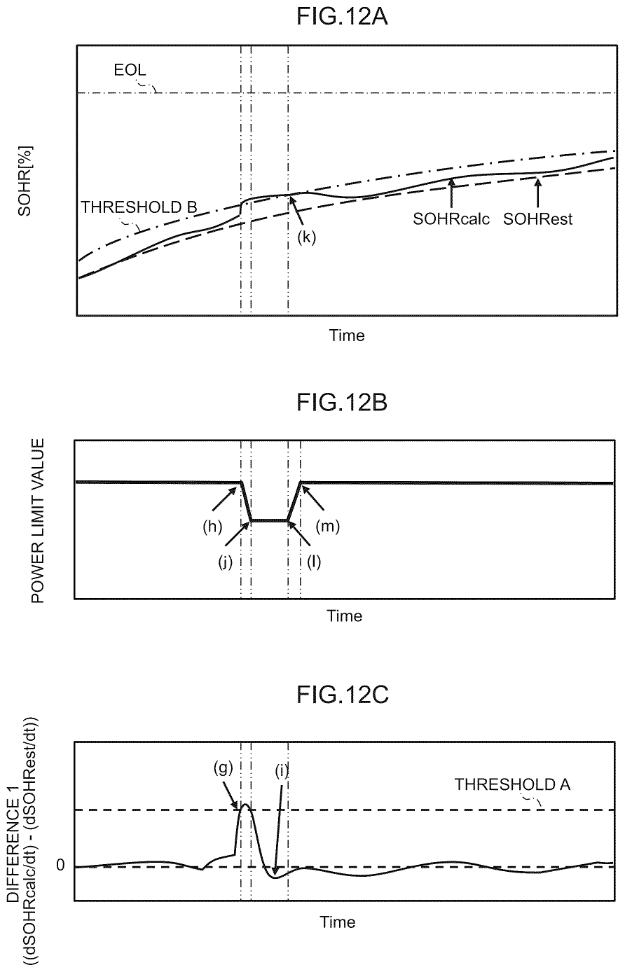

Effects of the method of controlling the battery 101 by the battery control apparatus 200 are described with reference to FIGS. 12A to 12C and the like. In the drawings, a model prediction value SOHRest (n) is represented by a curve that is gradually increased due to use of the battery 101 for a long time. To use the battery up to the predicted lifetime, it is important that the detection value SOHRcalc (m, o) is not largely deviated from the model prediction value SOHRest (n), namely, a difference therebetween does not exceed the threshold B.

In the present embodiment, when the resistance increase determination unit 503 determines that the difference 1 [(dSOHRcalc/dt)−(dSOHRest/dt)] exceeds the threshold A (g), the limit value correction unit 504 corrects and reduces the power limit value in synchronization the determination or without delay (h). As a result, the load to the battery 101 is reduced, and accordingly, the specific resistance increase is moderated, and the difference 1 is reduced. A reduction amount is continuously increased until the difference 1 becomes equal to or smaller than the threshold A. This creates a low-load state necessary for moderation of the specific resistance increase.

When the difference 1 becomes equal to or smaller than the threshold A, the correction amount of the power limit value is maintained until SOHRcalc becomes equal to or smaller than the threshold B. This creates a state where the resistance value is reduced by moderation of the specific resistance increase.

When SOHRcalc becomes equal to or smaller than the threshold B, the correction amount of the power limit value is reduced to moderate the power limitation. In addition, reduction of the correction amount is stopped at a time point when the correction amount becomes zero. This cancels unnecessary power limitation after the specific resistance increase is moderated. As a result, the power limit value of the battery can be returned to an original value as quickly as possible while the battery lifetime is maintained as expected, and performance of the battery 101 is recovered to a state before the specific increase of the resistance value occurs.

The above-described embodiment provides a first battery control apparatus (200) that includes: a calculation unit (deterioration calculation unit 232) configured to calculate a deterioration degree of a battery; a prediction unit (deterioration prediction unit 502) configured to predict the deterioration degree of the battery; and a control unit (assembled-battery control management unit 230) configured to limit charge/discharge of the battery based on comparison between change over time (time change amount, rate, degree, etc.) of the deterioration degree of the battery obtained by calculation of the calculation unit and change over time of the deterioration degree of the battery obtained by prediction of the prediction unit.

According to the first battery control apparatus, the specific increase of the battery resistance is detected and prevented at an early stage. Therefore, it is possible to realize battery control that can secure stable output of the load while suppressing unexpected abnormal resistance increase caused by continuous operation of the battery under the high load and other factors, and can effectively use the battery up to the predicted lifetime.

The above-described embodiment discloses a second battery control apparatus in which, in the first battery control apparatus, the control unit (assembled-battery control management unit 230) includes a determination unit (resistance increase determination unit 503) configured to determine a deterioration state of the battery based on a result of the comparison, and a limiting unit (limit value correction unit 504) configured to limit charge/discharge of the battery based on the determined deterioration state of the battery.

The above-described embodiment discloses a third battery control apparatus characterized in that, in the second battery control apparatus, the calculation unit calculates the deterioration degree of the battery based on detection data on the battery, the prediction unit predicts the deterioration degree of the battery based on a deterioration prediction model of the battery, and the determination unit calculates a difference between the change over time of the deterioration degree calculated by the calculation unit and the change over time of the deterioration degree predicted by the prediction unit, and determines the deterioration state of the battery based on the calculated difference.

The deterioration prediction model is a model obtained by modeling deterioration transition gradually increasing up to a required lifetime of the battery based on a normal use form of the battery.

The above-described embodiment discloses a fifth battery control apparatus characterized in that, in the third battery control apparatus, the determination unit compares the difference and a threshold, and determines the deterioration state of the battery in a case where the difference is out of the threshold, and the limiting unit limits charge/discharge of the battery based on the determined deterioration state of the battery, and continues the limited charge/discharge of the battery until the difference is within the threshold.

The above-described embodiment discloses a sixth battery control apparatus characterized in that, in the third battery control apparatus, the control unit (resistance increase threshold calculation unit 507) calculates the threshold based on an error in calculation of the deterioration degree of the battery and an error in prediction of the deterioration degree of the battery.

The above-described embodiment discloses a seventh battery control apparatus characterized in that, in the fifth battery control apparatus, the limiting unit includes a correction unit (limit value correction unit 504) configured to correct a limit value for limiting charge/discharge of the battery, and when the determination unit determines that the difference exceeds the threshold, the correction unit performs correction to reduce the limit value.

The above-described embodiment discloses an eighth battery control apparatus characterized in that, in the sixth battery control apparatus, the correction unit corrects the limit value to cause ΔV to be within a threshold, where ΔV is a difference between a CCV and an OCV of the battery.

The above-described embodiment discloses a ninth battery control apparatus characterized in that, in the seventh battery control apparatus, the correction unit corrects the limit value to gradually limit charge/discharge of the battery.

The above-described embodiment discloses a battery control method for a processor to control operation of a battery. The processor calculates a deterioration degree of the battery, predicts the deterioration degree of the battery, and limits charge/discharge of the battery based on comparison between change over time of the deterioration degree of the battery obtained by calculation and change over time of the deterioration degree of the battery obtained by prediction.

The above-described embodiment discloses a vehicle control apparatus (400) that is coupled to a power conversion unit 320 coupled to a motor 330 of a vehicle driving apparatus 300, and the battery control apparatus (200), and controls power supplied from the battery to the power conversion unit based on a limit value for limiting charge/discharge of the battery.

The present invention is not limited to the configuration described in the embodiment, and can be appropriately configured based on the disclosure of the claims. The above-described embodiment is an example for implementing the present invention. When the present invention is implemented, only a part of the configuration of the embodiment may be implemented.

When the present invention is implemented, the embodiment may be implemented by being added with a configuration not described in the embodiment. When the present invention is implemented, a part of the configuration of the embodiment may be replaced with a configuration not described in the embodiment. “Unit” of “**** unit” disclosed in the embodiment may be replaced with a term of module, means, section, circuit, or part. “d****/dt” disclosed in the embodiment may be replaced with “Δ****” indicating a change amount.

In addition, the module, the means, and the unit may be configured by combining electronic circuits. Such a configuration realizes a battery system that determines occurrence of specific resistance increase different from normal resistance increase at an early stage, and reduces a load of a battery based on a determination result to suppress resistance increase.

### REFERENCE SIGNS LIST

100 Assembled battery
101 Battery
200 Battery control apparatus
210 Battery management unit
211 Battery control unit
220 Detection unit
221 Current detection unit
222 Voltage detection unit
223 Temperature detection unit
230 Assembled-battery control management unit
231 SOC calculation unit
232 Deterioration calculation unit
233 Power limit calculation unit
234 Voltage equalization calculation unit
235 Diagnosis unit
240 Assembled-battery storage unit
300 Vehicle driving apparatus
310 Relay
320 Power conversion unit
330 Motor
340 Engine
400 Vehicle control apparatus
410 Vehicle control management unit
420 Vehicle storage unit
501 Limit value calculation unit
502 Deterioration prediction unit
503 Resistance increase determination unit
504 Limit value correction unit
505 Prediction calculation error information output unit
506 Detection calculation error information output unit
507 Resistance increase threshold calculation unit

1. A battery control apparatus, comprising:
a calculation unit configured to calculate a deterioration degree of a battery;
a prediction unit configured to predict the deterioration degree of the battery; and
a control unit configured to limit charge/discharge of the battery based on comparison between change over time of the deterioration degree of the battery obtained by calculation of the calculation unit and change over time of the deterioration degree of the battery obtained by prediction of the prediction unit.

2. The battery control apparatus according to claim 1, wherein the control unit includes a determination unit configured to determine a deterioration state of the battery based on a result of the comparison, and a limiting unit configured to limit charge/discharge of the battery based on the determined deterioration state of the battery.

3. The battery control apparatus according to claim 2, wherein
the calculation unit calculates the deterioration degree of the battery based on detection data on the battery,
the prediction unit predicts the deterioration degree of the battery based on a deterioration prediction model of the battery, and
the determination unit calculates a difference between the change over time of the deterioration degree calculated by the calculation unit and the change over time of the deterioration degree predicted by the prediction unit, and determines the deterioration state of the battery based on the calculated difference.

4. The battery control apparatus according to claim 3, wherein the deterioration prediction model is obtained by modeling deterioration transition gradually increasing up to a required lifetime of the battery based on a normal use form of the battery.

5. The battery control apparatus according to claim 3, wherein
the determination unit compares the difference and a threshold, and determines the deterioration state of the battery in a case where the difference is out of the threshold, and
the limiting unit limits charge/discharge of the battery based on the determined deterioration state of the battery, and continues the limited charge/discharge of the battery until the difference is within the threshold.

6. The battery control apparatus according to claim 5, wherein the control unit calculates the threshold based on an error in calculation of the deterioration degree of the battery and an error in prediction of the deterioration degree of the battery.

7. The battery control apparatus according to claim 5, wherein
the limiting unit includes a correction unit configured to correct a limit value for limiting charge/discharge of the battery, and
when the determination unit determines that the difference exceeds the threshold, the correction unit performs correction to reduce the limit value.

8. The battery control apparatus according to claim 7, wherein the correction unit corrects the limit value to cause ΔV to be within a threshold, where ΔV is a difference between a CCV and an OCV of the battery.

9. The battery control apparatus according to claim 7, wherein the correction unit corrects the limit value to gradually limit charge/discharge of the battery.

10. A battery control method for a processor to control operation of a battery, wherein
the processor calculates a deterioration degree of the battery, predicts the deterioration degree of the battery, and limits charge/discharge of the battery based on comparison between change over time of the deterioration degree of the battery obtained by calculation and change over time of the deterioration degree of the battery obtained by prediction.

11. A vehicle control apparatus coupled to a power conversion unit coupled to a motor of a vehicle driving apparatus, and the battery control apparatus according to claim 1, the vehicle control apparatus controlling power supplied from the battery to the power conversion unit based on a limit value for limiting charge/discharge of the battery.
